(19) United States
(12) Patent Application Publication
(10) Pub. No.: US 2025/0085239 A1
(43) Pub. Date: Mar. 13, 2025

(54) MASS ESTIMATION METHOD AND X-RAY INSPECTION APPARATUS

(71) Applicant: ANRITSU CORPORATION, Kanagawa (JP)

(72) Inventor: Michihiko IKEDA, Kanagawa (JP)

(21) Appl. No.: 18/822,903

(22) Filed: Sep. 3, 2024

(30) Foreign Application Priority Data
Sep. 11, 2023 (JP) 2023-147047

(51) Int. Cl. G01N 23/10; G01N 23/083

(52) U.S. Cl. CPC G01N 23/10; G01N 23/083; G01N 2223/3037; G01N 2223/304; G01N 2223/3307

(57) ABSTRACT

A mass estimation method includes a step of generating X-ray transmission image data for each transmission region of a sample of an inspection object, a step of generating a histogram of pixel values of pixels that are included in N pieces of the X-ray transmission image data of the sample and that correspond to the respective transmission regions, a step of generating a histogram matrix consisting of N row vectors corresponding to N histograms of the sample, a step of using a product of the histogram matrix and a weight vector consisting of a weight coefficient for each pixel value of the N pieces of X-ray transmission image data, to calculate the weight vector that minimizes a variance of the N relative mass estimation values, and a step of estimating mass of the inspection object by using the weight vector.

### TECHNICAL FIELD

The present invention relates to a mass estimation method and an X-ray inspection apparatus with which an inspection object is irradiated with X-rays and the mass is estimated based on a transmission amount of the X-rays.

### BACKGROUND ART

In general, an X-ray inspection apparatus emits X-rays with a width in a direction orthogonal to a passing direction of an inspection object in to a passing path of the inspection object, receives the X-rays transmitted through the inspection object via a plurality of sensor elements arranged in the direction orthogonal to the passing direction of the inspection object, acquires an X-ray transmission image showing a difference in an transmission amount of the X-rays for each part of the inspection object for the X-rays by shading, and performs various types of processing on the X-ray transmission image, thereby determining whether a foreign matter is contained, whether contents are missing or damaged, or the like.

In addition, in recent years, an X-ray inspection apparatus that can estimate the mass of an inspection object based on a transmission amount of X-rays of the inspection object has been proposed (see, for example, Patent Documents 1 and 2).

Here, the interaction between the X-rays and the inspection object will be described. In a case where the X-rays are transmitted through the inspection object, the X-rays are attenuated due to the interaction (absorption, scattering, or the like) with the inspection object. This attenuation rate is indicated by a linear attenuation coefficient μ[1/cm], and a value obtained by dividing the linear attenuation coefficient μ by a density ρ [g/cm³] of the inspection object is referred to as a mass attenuation coefficient μₘ [cm²/g].

Here, in a case where an X-ray irradiation amount from an X-ray source is denoted by I₀, the transmission amount of the X-rays is denoted by I, and a thickness of the inspection object is denoted by t [cm], Expression (1) holds true.

$$I = {I}_{0} exp ( - {µ}_{m} ρ t ) \qquad ( 1 )$$

Here, since the transmission amount I of the X-rays is a product y(k)A of transmission data y(k) of each unit transmission region obtained from the X-ray source and a correction coefficient A, Expression (1) is transformed to Expression (2).

$$y ( k ) A = {I}_{0} exp ( - {μ}_{m} ρ t ) \qquad ( 2 )$$

In a case where Expression (2) is transformed, Expression (3) is obtained.

$$ρ t = - 1 / {μ}_{m} \times ln [ y ( k ) A / {I}_{0} ] \qquad ( 3 )$$

Here, a unit of a left side ρt of Expression (3) is [g/cm³]×[cm]=[g/cm²], and a right side of Expression (3) is the mass of a certain unit transmission region (unit area of 1 cm²). The unit mass for each unit transmission region is calculated by substituting the measurement parameters μₘ, I₀, A, and the transmission data y(k) into Expression (3) for each unit transmission region.

Then, the unit mass for each unit transmission region is summed over the entire transmission region of the transmitted X-rays that are transmitted through the inspection object. That is, the total mass M of the inspection object is calculated by summing the unit mass calculated for each unit transmission region, based on Expression (4).

$$M = {\sum }_{k = 1}^{n} \{ - \frac{1}{{μ}_{m}} ln [ \frac{y ( k ) A}{{I}_{0}} ] \} \qquad ( 4 )$$

### RELATED ART DOCUMENT

### Patent Document

[Patent Document 1] Japanese Patent No. 5651007
[Patent Document 2] JP-A-2002-296022

### DISCLOSURE OF THE INVENTION

### Problem that the Invention is to Solve

However, in the X-ray inspection apparatus using such X-rays, due to a change in the transmission amount of the X-rays caused by whether the foreign matter is contained in the inspection object, whether the contents are missing or damaged, or the like, as well as the X-rays being emitted to spread toward an inspection region, the intensity of the X-rays incident on each sensor element is not uniform.

In addition, a difference in the sensitivity for each sensor element occurs, or a difference in the sensitivity for each array or each module occurs in a case where a plurality of arrays or modules, each composed of a plurality of sensor elements.

Therefore, in the related art, the measurement parameters μₘ, I₀, and A are adjusted to change a shape of a curve of Expression (3), thereby attempting to suppress a variation for each measurement in the total mass M of the inspection object obtained based on Expression (4). However, with this method, there is an issue in that a difference in the appearance depending on a placement position of the inspection object on a transport belt or a difference in the appearance depending on a height of the inspection object cannot be sufficiently compensated for by adjusting the measurement parameters.

The present invention has been made to address such an issue in the related art, and an object of the present invention is to provide a mass estimation method and an X-ray inspection apparatus with which the mass of an inspection object can be accurately estimated by calculating a weight vector by using X-ray transmission image data for calibration.

### Means for Solving the Problem

In order to achieve the above-described object, a first aspect of the present invention provides a mass estimation method including: a first transport step of transporting a sample that is the same type as an inspection object and that has known mass N times while irradiating the sample with X-rays; a first X-ray transmission image data generation step of generating, for each transportation, X-ray transmission image data corresponding to a transmission amount of the X-rays for each transmission region of the sample transported in the first transport step; a first histogram generation step of generating a histogram of pixel values of pixels that are included in N pieces of the X-ray transmission image data of the sample generated in the first X-ray transmission image data generation step and that correspond to the respective transmission regions; a histogram matrix generation step of generating a histogram matrix consisting of N row vectors corresponding to N histograms of the sample generated in the first histogram generation step; a weight vector calculation step of using a product of the histogram matrix and a weight vector consisting of a weight coefficient for each pixel value of the N pieces of X-ray transmission image data as a relative mass estimation value vector consisting of N relative mass estimation values of the sample, to calculate the weight vector that minimizes a variance of the N relative mass estimation values; and a mass estimation step of estimating mass of the inspection object that is transported, by using the weight vector calculated in the weight vector calculation step.

As a result, with the mass estimation method according to the first aspect of the present invention, in a calibration mode, the X-ray transmission image data of the sample of the inspection object can be generated N times, and the weight vector consisting of the weight coefficient for each pixel value of a plurality of pixels included in each of the N pieces of X-ray transmission image data can be calculated. That is, with the mass estimation method according to the first aspect of the present invention, a relationship between the pixel value and the mass is not approximated by a curve such as Expression (3) as in the related art, but the weight coefficient, which is the correction coefficient for calculating the mass of the inspection object, is calculated for each pixel value. As a result, with the mass estimation method according to the first aspect of the present invention, the mass of the inspection object can be estimated with high estimation accuracy by using the weight vector in an inspection mode in which the inspection object is transported.

In a second aspect of the present invention, the mass estimation method according to the first aspect may further include: a relative mass estimation value vector calculation step of calculating the product of the histogram matrix and the weight vector calculated in the weight vector calculation step as the relative mass estimation value vector; and a reference mass calculation step of calculating a representative value of the N relative mass estimation values included in the relative mass estimation value vector calculated in the relative mass estimation value vector calculation step as reference mass.

With this configuration, with the mass estimation method according to the second aspect of the present invention, the reference mass in a case of estimating the mass of the inspection object can be calculated.

In a third aspect of the present invention, the mass estimation method according to the second aspect may further include: a second transport step of sequentially transporting one or more inspection objects that are transported, while irradiating the one or more inspection objects with X-rays; a second X-ray transmission image data generation step of generating X-ray transmission image data corresponding to a transmission amount of the X-rays for each transmission region of the inspection object transported in the second transport step; and a second histogram generation step of generating a histogram of pixel values of pixels that are included in the X-ray transmission image data of the inspection object generated in the second X-ray transmission image data generation step and that correspond to the respective transmission regions, in which the mass estimation step includes a histogram vector generation step of generating a histogram vector consisting of one row vector corresponding to the histogram of the inspection object generated in the second histogram generation step, a relative mass calculation step of calculating a product of the histogram vector and the weight vector calculated in the weight vector calculation step as relative mass of the inspection object, and a mass conversion step of converting the relative mass into the mass of the inspection object based on a ratio between the known mass of the sample and the reference mass.

With this configuration, with the mass estimation method according to the third aspect of the present invention, the relative mass of the inspection object can be calculated by using the weight vector, the relative mass can be converted into the mass of the inspection object based on the ratio between the known mass of the sample and the reference mass.

In a fourth aspect of the present invention, the mass estimation method according to the third aspect may further include: a mass pass/fail determination step of determining whether the mass converted in the mass conversion step is within a predetermined mass tolerance corresponding to the inspection object.

With this configuration, with the mass estimation method according to the fourth aspect of the present invention, whether the mass of the inspection object is within the predetermined mass tolerance can be determined.

A fifth aspect of the present invention provides an X-ray inspection apparatus including: a transport unit that transports a sample that is the same type as an inspection object and that has known mass N times; an X-ray source that irradiates the sample transported by the transport unit with X-rays; an X-ray detector that detects the X-rays transmitted through the sample for each transmission region of the sample; an X-ray transmission image data generation unit that generates, for each transportation, X-ray transmission image data corresponding to a transmission amount of the X-rays for each transmission region of the sample based on detection information of the X-ray detector; a histogram generation unit that generates a histogram of pixel values of pixels that are included in N pieces of the X-ray transmission image data of the sample generated by the X-ray transmission image data generation unit and that correspond to the respective transmission regions; a histogram matrix generation unit that generates a histogram matrix consisting of N row vectors corresponding to N histograms of the sample generated by the histogram generation unit; a weight vector calculation unit that uses a product of the histogram matrix and a weight vector consisting of a weight coefficient for each pixel value of the N pieces of X-ray transmission image data as a relative mass estimation value vector consisting of N relative mass estimation values of the sample, to calculate the weight vector that minimizes a variance of the N relative mass estimation values; and a mass estimation unit that estimates mass of one or more inspection objects transported by the transport unit, by using the weight vector calculated by the weight vector calculation unit.

In a sixth aspect of the present invention, the X-ray inspection apparatus according to the fifth aspect may further include: a relative mass estimation value vector calculation unit that calculates the product of the histogram matrix and the weight vector calculated by the weight vector calculation unit as the relative mass estimation value vector; and a reference mass calculation unit that calculates a representative value of the N relative mass estimation values included in the relative mass estimation value vector calculated by the relative mass estimation value vector calculation unit as reference mass.

A seventh aspect of the present invention provides the X-ray inspection apparatus according to the sixth aspect, in which, in an inspection mode in which the one or more inspection objects are transported by the transport unit, the X-ray source may irradiate the inspection object that is transported by the transport unit with X-rays, the X-ray detector may detect the X-rays transmitted through the inspection object for each transmission region of the inspection object, the X-ray transmission image data generation unit may generate the X-ray transmission image data corresponding to a transmission amount of the X-rays for each transmission region of the inspection object based on detection information of the X-ray detector, and the histogram generation unit may generate a histogram of pixel values of pixels that are included in the X-ray transmission image data of the inspection object generated by the X-ray transmission image data generation unit and that correspond to the respective transmission regions, and the mass estimation unit may include a histogram vector generation unit that generates a histogram vector consisting of one row vector corresponding to the histogram of the inspection object generated by the histogram generation unit, a relative mass calculation unit that calculates a product of the histogram vector and the weight vector calculated by the weight vector calculation unit as relative mass of the inspection object, and a mass conversion unit that converts the relative mass into the mass of the inspection object based on a ratio between the known mass of the sample and the reference mass.

In an eighth aspect of the present invention, the X-ray inspection apparatus according to the fifth aspect may further include: a foreign matter determination unit that determines whether a foreign matter is contained in the inspection object based on the detection information of the X-ray detector. In a ninth aspect of the present invention, the X-ray inspection apparatus according to the sixth aspect may further include: a foreign matter determination unit that determines whether a foreign matter is contained in the inspection object based on the detection information of the X-ray detector. In a tenth aspect of the present invention, the X-ray inspection apparatus according to the seventh aspect may further include: a foreign matter determination unit that determines whether a foreign matter is contained in the inspection object based on the detection information of the X-ray detector.

With this configuration, the X-ray inspection apparatus according to the eighth to tenth aspects of the present invention can determine whether the foreign matter is contained in the inspection object.

### Advantage of the Invention

The present invention provides the mass estimation method and the X-ray inspection apparatus with which the mass of the inspection object can be accurately estimated by calculating the weight vector by using the X-ray transmission image data for calibration.

### BRIEF DESCRIPTION OF THE DRAWINGS

FIG. 1 is a schematic configuration diagram of an X-ray inspection apparatus according to an embodiment of the present invention.

FIG. 2 is a diagram schematically showing an example of a plurality of pieces of X-ray transmission image data generated by an X-ray transmission image data generation unit in a calibration mode of the X-ray inspection apparatus according to the embodiment of the present invention.

FIG. 3 is a flowchart showing processing of a mass estimation method using the X-ray inspection apparatus according to the embodiment of the present invention.

FIG. 4 is a flowchart showing details of the processing of step S3 of the flowchart of FIG. 3.

### BEST MODE FOR CARRYING OUT THE INVENTION

Hereinafter, embodiments of a mass estimation method and an X-ray inspection apparatus according to the present invention will be described with reference to the accompanying drawings.

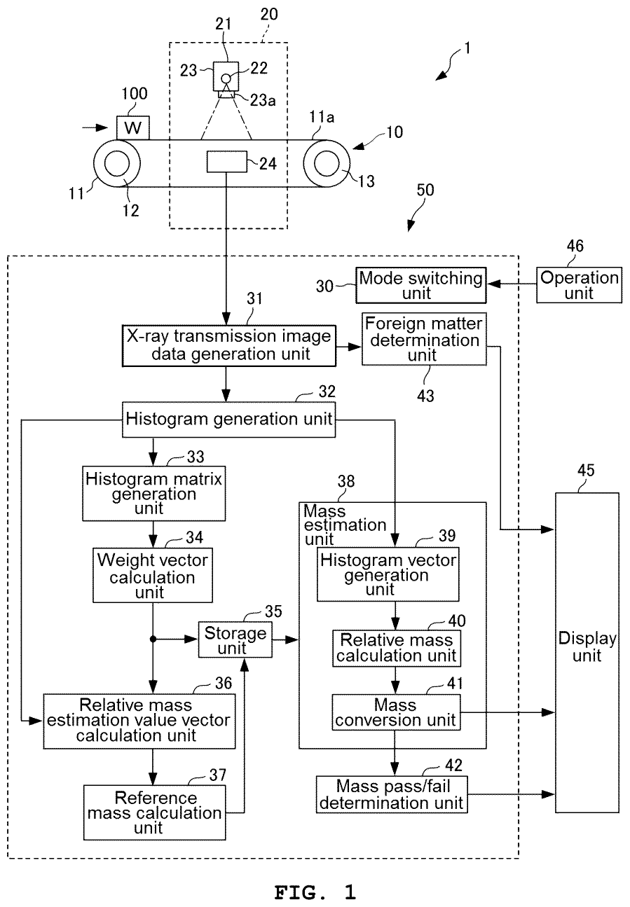

FIG. 1 is a diagram showing a configuration of an X-ray inspection apparatus 1. The X-ray inspection apparatus 1 has a function of estimating the mass of an inspection object 100 (article) that is transported. Examples of the inspection object 100 include a fruit, a vegetable, a marine product, packaged raw meat, processed food, or medicine.

As shown in FIG. 1, the X-ray inspection apparatus 1 includes a transport unit 10, an X-ray inspection unit 20, and a control unit 50, which includes a display unit 45 and an operation unit 46.

The transport unit 10 is a conveyor that winds a loop-shaped transport belt 11 around a plurality of transport rollers 12 and 13 and that sequentially transports the inspection object 100 or a sample thereof placed on a transport surface 11a of the transport belt 11 in a right direction in FIG. 1, thereby enabling the inspection object 100 or the sample thereof to pass through a predetermined inspection section of the X-ray inspection unit 20, and the transport unit 10 is supported by a housing (not shown). The sample is, for example, a typical good product that is the same type as the inspection object 100, and has known mass. The placement of the inspection object 100 or the sample thereof on the transport belt 11 may be performed manually by a user or performed by a dedicated device (not shown). Hereinafter, the inspection object 100 and the sample thereof may be collectively referred to as the “inspection object 100”.

The transport unit 10 is configured to transport the inspection object 100 to the X-ray inspection unit 20 at a predetermined constant transport speed corresponding to the type of the inspection object 100. The transport unit 10 is configured to sequentially transport one or more inspection objects 100 in the right direction in FIG. 1 in a case where an operation mode of the X-ray inspection apparatus 1 is in an inspection mode described later. On the other hand, the transport unit 10 is configured to transport the sample of the inspection object 100 in the right direction in FIG. 1 N times in a case where the operation mode of the X-ray inspection apparatus 1 is in a calibration mode described later.

The X-ray inspection unit 20 includes an X-ray source 21 that irradiates the inspection object 100, which is transported by the transport unit 10, with X-rays of a predetermined energy band transmitted through the inspection object 100. The X-ray source 21 is configured to generate the X-rays with a wavelength and intensity corresponding to a tube current and a tube voltage of a known X-ray tube 22, and irradiate the inspection object 100 on the transport belt 11 with fan-beam X-rays in a direction orthogonal to a transport direction of the transport unit 10 through an X-ray window portion 23a of an envelope 23.

The X-ray inspection unit 20 further includes an X-ray detector 24 disposed directly below the transport belt 11.

Although not shown in detail, the X-ray detector 24 is configured by an X-ray line sensor camera in which detection elements, which consist of a scintillator as a phosphor and a photodiode or a charge-coupled device, are disposed in an array at a predetermined pitch in a width direction of a transport path of the transport unit 10, to detect the X-rays at a predetermined resolution.

That is, the X-ray detector 24 is configured to detect the X-rays emitted from the X-ray source 21 and transmitted through the inspection object 100 for each predetermined transmission region of the inspection object 100 corresponding to the detection element, and convert the detected X-rays into an electric signal corresponding to a transmission amount of the detected X-rays, to output an X-ray detection signal for each transmission region.

The control unit 50 is configured to control a transport speed, a transport interval, and the like of the inspection object 100 via the transport belt 11 in the transport unit 10. Further, the control unit 50 is configured to control the X-ray irradiation intensity and irradiation period in the X-ray inspection unit 20, or control an X-ray detection cycle of the X-ray line sensor of the X-ray detector 24 and a detection period of the inspection object 100 according to the transport speed of the inspection object 100. Further, the control unit 50 includes a counter (not shown) that counts the number of times of transportation of the sample of the inspection object 100 via the transport unit 10, and is configured to display a count result on the display unit 45.

The control unit 50 further includes a mode switching unit 30, an X-ray transmission image data generation unit 31, a histogram generation unit 32, a histogram matrix generation unit 33, a weight vector calculation unit 34, a storage unit 35, a relative mass estimation value vector calculation unit 36, a reference mass calculation unit 37, a mass estimation unit 38, a mass pass/fail determination unit 42, and a foreign matter determination unit 43.

The mode switching unit 30 switches the operation mode of the X-ray inspection apparatus 1 between the inspection mode in which a normal inspection is performed on the inspection object 100 and the calibration mode for acquiring a reference mass W_{Sm} for estimating the mass of the inspection object 100. For example, the mode switching unit 30 is configured to select the operation mode of the X-ray inspection apparatus 1 in response to an operation input performed by the user on the operation unit 46.

The X-ray transmission image data generation unit 31 is configured to incorporate the X-ray detection signal for each predetermined cycle from the X-ray detector 24 and generate X-ray transmission image data of the inspection object 100 consisting of information on a two-dimensional position determined a passing direction of the inspection object 100 and an arrangement direction of the detection elements and a signal processing result for each position. The X-ray transmission image data is, for example, digital data of pixel values with 4096 gradations ranging from 0 to 4095, corresponds to the transmission amount of the X-rays for each transmission region of the inspection object 100. For example, each pixel constituting the X-ray transmission image data corresponds to each transmission region of the inspection object 100. The X-ray transmission image data generation unit 31 generates the X-ray transmission image data each time the inspection object 100 is transported to the X-ray inspection unit 20 and passes through the predetermined inspection section. That is, the X-ray transmission image data generation unit 31 generates N pieces of X-ray transmission image data for one sample of the inspection object 100 in a case where the operation mode of the X-ray inspection apparatus 1 is the calibration mode described later.

Hereinafter, a configuration related to an operation of the X-ray inspection apparatus 1 in the calibration mode will be described.

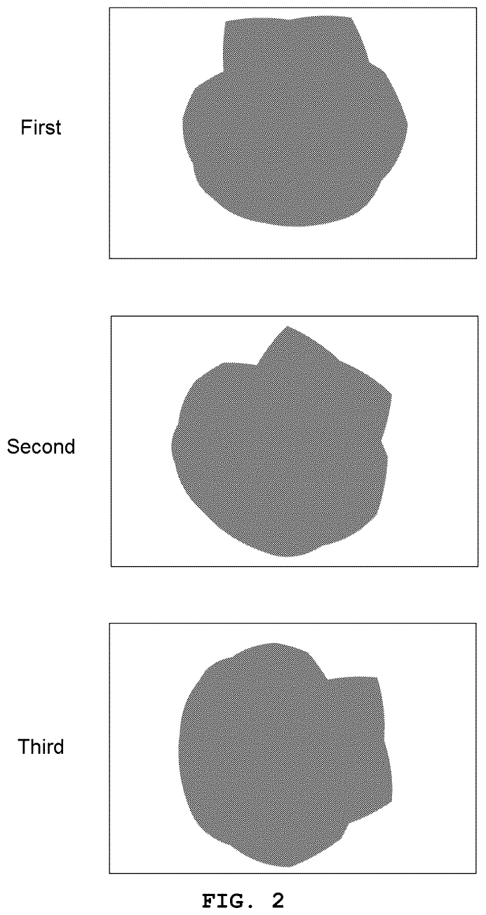

FIG. 2 is a diagram schematically showing an example of a plurality of pieces of X-ray transmission image data generated by the X-ray transmission image data generation unit 31 in the calibration mode. An upper part, a middle part, and a lower part of FIG. 2 show examples of the X-ray transmission image data of the sample obtained by a first transportation, a second transportation, and a third transportation by the transport unit 10, respectively. In this way, it is desirable to change a position or an orientation at which the sample is placed on the transport belt 11 of the transport unit 10 for each transportation via the transport unit 10, to obtain different X-ray transmission image data for each transportation.

The position or the orientation at which the sample is placed on the transport belt 11 of the transport unit 10 may be changed by the user in a case of placing the sample on the transport belt 11. Alternatively, various mechanisms for changing the position or the orientation of the sample on the transport belt 11 may be provided in the transport unit 10.

The histogram generation unit 32 is configured to generate a histogram {h_{i,n}} of pixel values of the plurality of pixels included in each of the N pieces of X-ray transmission image data of the sample generated by the X-ray transmission image data generation unit 31. Here, i is an index indicating the pixel value of I gradations, and is an integer from 0 to the maximum pixel value I−1. In addition, n is an index indicating the number of times of transportation of the sample of the inspection object 100, and is an integer from 1 to the total number of times of transportation N.

The histogram matrix generation unit 33 is configured to generate a histogram matrix consisting of N row vectors corresponding to N histograms of the sample generated by the histogram generation unit 32. That is, as shown in Expression (5), the histogram matrix generated by the histogram matrix generation unit 33 is a matrix having a frequency h_{i,n} of the histogram generated by the histogram generation unit 32 as an element.

$$( \begin{matrix}{h}_{0 , 1} & {h}_{1 , 1} & … & {h}_{I - 1 , 1} \\ {h}_{0 , 2} & {h}_{1 , 2} & … & {h}_{I - 1 , 2} \\ ⋮ & ⋮ & ⋱ & ⋮ \\ {h}_{0 , N} & {h}_{1 , N} & … & {h}_{I - 1 , N}\end{matrix} ) \qquad ( 5 )$$

Here, the sum of the products of the frequency h_{i,n} for each pixel value of the X-ray transmission image data of the sample of the inspection object 100 and a weight coefficient wᵢ will be referred to as a relative mass estimation value Wₙ. There are I weight coefficients wᵢ corresponding to the pixel value of I gradations. That is, as shown in Expression (6), the relative mass estimation value vector W consisting of N relative mass estimation values Wₙ of the sample is the product of the histogram matrix generated by the histogram matrix generation unit 33 and the weight vector w consisting of the weight coefficient wᵢ for each pixel value of the N pieces of X-ray transmission image data.

$$( \begin{matrix}{h}_{0 , 1} & {h}_{1 , 1} & … & {h}_{I - 1 , 1} \\ {h}_{0 , 2} & {h}_{1 , 2} & … & {h}_{I - 1 , 2} \\ ⋮ & ⋮ & ⋱ & ⋮ \\ {h}_{0 , N} & {h}_{1 , N} & … & {h}_{I - 1 , N}\end{matrix} ) ( \begin{matrix}{w}_{0} \\ {w}_{1} \\ ⋮ \\ {w}_{I - 1}\end{matrix} ) = ( \begin{matrix}{W}_{1} \\ {W}_{2} \\ ⋮ \\ {W}_{N}\end{matrix} ) \qquad ( 6 )$$

The weight vector calculation unit 34 is configured to calculate the weight vector w that minimizes the variance of the N relative mass estimation values Wₙ. Hereinafter, a method of calculating the weight vector w via the weight vector calculation unit 34 will be described.

The relative mass estimation value Wₙ in a case where the number of times of transportation is n-th transportation is expressed by Expression (7). In addition, an average value of the N relative mass estimation values Wₙ is expressed by Expression (8).

$${W}_{n} = {\sum }_{i = 0}^{I - 1} {h}_{i , n} {w}_{i} \qquad ( 7 )$$

$$\overline{W} = \frac{1}{N} {\sum }_{n = 1}^{N} {W}_{n} \qquad ( 8 )$$

Therefore, a variance V of the N relative mass estimation values Wₙ is expressed by Expression (9).

$$\begin{matrix}V = \frac{1}{N} {\sum }_{n = 1}^{N} {( {W}_{n} - \overline{W} )}^{2} = \frac{1}{N} {\sum }_{n = 1}^{N} {[ {\sum }_{i = 0}^{I - 1} ( {h}_{i , n} - \frac{1}{N} {\sum }_{m = 1}^{N} {h}_{i , m} ) {w}_{i} ]}^{2} \\ = \frac{1}{N} {\sum }_{n = 1}^{N} {( {\sum }_{i = 0}^{I - 1} {H}_{i , n} {w}_{i} )}^{2}\end{matrix} \qquad ( 9 )$$

### Here,

$${H}_{i , n} = {h}_{i , n} - \frac{1}{N} {\sum }_{m = 1}^{N} {h}_{i , m}$$

indicates a bias of the histogram at the pixel value i.

Here, in a case where Expression (9) is expanded, Expression (10) is obtained.

$$V = \frac{1}{N} {\sum }_{n = 1}^{N} {\sum }_{i ( \neq j ) = 0}^{I - 1} [ {( {H}_{i , n} {w}_{i} )}^{2} + {( {H}_{j , n} {w}_{j} )}^{2} + 2 {H}_{i , n} {w}_{i} {H}_{j , n} {w}_{j} ] \qquad ( 10 )$$

Therefore, a minimal condition of the variance V, that is, the condition in which a value obtained by partially differentiating the variance V with respect to w is 0, is expressed by Expression (11).

$$\frac{\partial V}{\partial {w}_{j}} = \frac{2}{N} {\sum }_{n = 1}^{N} {\sum }_{i ( \neq j ) = 0}^{I - 1} ( {H}_{j , n}^{2} {w}_{j} + {H}_{i , n} {H}_{j , n} {w}_{i} ) = 2 {\sum }_{i = 0}^{I - 1} ( \frac{1}{N} {\sum }_{n = 1}^{N} {H}_{i , n} {H}_{j , n} ) {w}_{i} = 0 \qquad ( 11 )$$

Here, Expression (11) is rewritten as Expression (13) using a component C_{j,i} of a covariance matrix C of the histogram shown in Expression (12).

$${C}_{j , i} = \frac{1}{N} {\sum }_{n = 1}^{N} {H}_{i , n} {H}_{j , n} = \frac{1}{N} {\sum }_{m = 1}^{N} ( {h}_{i , n} - \frac{1}{N} {\sum }_{m = 1}^{N} {h}_{i , m} ) ( {h}_{j , n} - \frac{1}{N} {\sum }_{m = 1}^{N} {h}_{j , m} ) \qquad ( 12 )$$

$${\sum }_{i = 0}^{I - 1} {C}_{j , i} {w}_{i} = 0 \qquad ( 13 )$$

The weight coefficient wᵢ, which is an unknown in Expression (13), is obtained as a solution of homogeneous polynomial Cw=0 in which the covariance matrix C is a coefficient. As shown in Expression (14), the covariance matrix C is an I-row by N-column matrix consisting of the product of a matrix H having a bias H_{i,n} of the histogram at the pixel value i as an elements and a transposed matrix Hₜ thereof.

$$C = \frac{1}{N} {HH}^{t} \qquad ( 14 )$$

The number of rows I of the matrix H is equal to the number of bars in the histogram, while the number of columns N of the matrix H is equal to the number of pieces of the X-ray transmission image data. In general, I>N. The rank of the matrix H, that is, the number of independent rows, is at most N, and thus the matrix C is a singular matrix. By obtaining a non-trivial solution w≠0 of the homogeneous polynomial Cw=0, the weight vector w that minimizes the variance V can be determined.

In the method of calculating the weight vector w, for the pixel value equal to or less than a predetermined noise cut threshold value in the X-ray transmission image data and for the pixel value in a region (for example, corresponding to the transport belt 11) other than a region corresponding to the inspection object 100, the corresponding weight coefficient wᵢ may be set to 0. As a result, the weight coefficient wᵢ can be accurately calculated while reducing an amount of computation.

The relative mass estimation value vector calculation unit 36 is configured to calculate the product of the histogram matrix generated by the histogram matrix generation unit 33 and the weight vector w calculated by the weight vector calculation unit 34 as the relative mass estimation value vector W. That is, the relative mass estimation value vector calculation unit 36 calculates the relative mass estimation value vector W by substituting the histogram matrix generated by the histogram matrix generation unit 33 and a final weight vector w calculated by the weight vector calculation unit 34 into Expression (6).

The reference mass calculation unit 37 is configured to calculate a representative value of the N relative mass estimation values Wₙ included in the relative mass estimation value vector W calculated by the relative mass estimation value vector calculation unit 36 as a reference mass W_{Sm}. Here, the representative value of the N relative mass estimation values Wₙ is, for example, any one of an average value, a median value, a mode value, a maximum value, or a minimum value of the N relative mass estimation values Wₙ. Which of the above-described representative values is used as the reference mass W_{Sm} may be selected by the operation input performed by the user on the operation unit 46. In a case where the representative value is the average value of the N relative mass estimation values Wₙ, the reference mass calculation unit 37 calculates the reference mass W_{Sm} by substituting the N relative mass estimation values W₁ to W_{N} into Expression (8).

The storage unit 35 includes a table (not shown) in which the weight vector w calculated by the weight vector calculation unit 34, the reference mass W_{Sm} calculated by the reference mass calculation unit 37, and the known mass W_{Km} of the sample of the inspection object 100 are stored in association with the type of the inspection object 100.

Hereinafter, a configuration related to an operation of the X-ray inspection apparatus 1 in the inspection mode in which the one or more inspection objects 100 are sequentially transported by the transport unit 10 will be described.

The histogram generation unit 32 is configured to generate a histogram {hᵢ} of pixel values of the plurality of pixels included in the X-ray transmission image data of the inspection object 100 generated by the X-ray transmission image data generation unit 31. Here, i is an index indicating the pixel value of I gradations, and is an integer from 0 to the maximum pixel value I−1.

The mass estimation unit 38 estimates the mass of the inspection object 100 by using the weight vector w stored in the table of the storage unit 35, the reference mass W_{Sm}, and the known mass W_{Km} of the sample, and includes a histogram vector generation unit 39, a relative mass calculation unit 40, and a mass conversion unit 41.

As shown in Expression (15), the histogram vector generation unit 39 is configured to generate a histogram vector consisting of one row vector corresponding to the histogram of the inspection object 100 generated by the histogram generation unit 32.

$$( \begin{matrix}{h}_{0} & {h}_{1} & … & {h}_{I - 1}\end{matrix} ) \qquad ( 15 )$$

As shown in Expression (16), the relative mass calculation unit 40 calculates the product of the histogram vector and the weight vector w stored in the table of the storage unit 35 as a relative mass Wᵣₘ of the inspection object 100. That is, the relative mass Wᵣₘ is the sum of the products of the frequency hᵢ for each pixel value of the X-ray transmission image data of the inspection object 100 and the weight coefficient wᵢ.

$${W}_{rm} = ( \begin{matrix}{h}_{0} & {h}_{1} & … & {h}_{I - 1}\end{matrix} ) ( \begin{matrix}{w}_{0} \\ {w}_{1} \\ ⋮ \\ {w}_{I}\end{matrix} ) = {\sum }_{i = 0}^{I - 1} {h}_{i} {w}_{i} \qquad ( 16 )$$

The mass conversion unit 41 is configured to convert the relative mass Wᵣₘ calculated by the relative mass calculation unit 40 into the mass of the inspection object 100. The information on the mass calculated by the mass conversion unit 41 is displayed on the display unit 45.

For example, the mass conversion unit 41 converts the relative mass Wᵣₘ into the mass of the inspection object 100 by multiplying the relative mass Wᵣₘ by a ratio between the known mass W_{Km} of the sample stored in the table of the storage unit 35 and the reference mass W_{Sm}. That is, the mass of the inspection object 100 is expressed by Expression (17).

$$Mass of inspection object = relative mass {W}_{rm} \times mass {W}_{Km} o f sample / reference mass {W}_{Sm} \qquad ( 17 )$$

The mass pass/fail determination unit 42 is configured to determine pass or fail of a mass measurement result based on whether the mass calculated by the mass conversion unit 41 is within a predetermined mass tolerance corresponding to the inspection object 100. The information on the pass/fail of the mass measurement result obtained by the mass pass/fail determination unit 42 is displayed on the display unit 45.

The foreign matter determination unit 43 is configured to determine whether a foreign matter is contained in the inspection object 100 based on the detection information from the X-ray detector 24. For example, the foreign matter determination unit 43 is configured to execute image processing such as a filter for emphasizing foreign matter information and extracting foreign matter information as a foreign matter extraction image on the X-ray transmission image data generated by the X-ray transmission image data generation unit 31, and detect whether the foreign matter is contained in the inspection object 100. Examples of the filter for emphasizing the foreign matter information include a feature extraction filter such as a differential filter (Roberts filter, Prewitt filter, or Sobel filter) or a Laplacian filter. The determination result of the foreign matter determination unit 43 is displayed on the display unit 45.

The control unit 50 is configured by, for example, a control device such as a computer including a central processing unit (CPU), a graphics processing unit (GPU), a field programmable gate array (FPGA), a read only memory (ROM), a random access memory (RAM), a hard disk drive (HDD), and the like. For example, the control unit 50 can execute a predetermined program by the CPU or the GPU to configure at least a part of the mode switching unit 30, the X-ray transmission image data generation unit 31, the histogram generation unit 32, the histogram matrix generation unit 33, the weight vector calculation unit 34, the relative mass estimation value vector calculation unit 36, the reference mass calculation unit 37, the mass estimation unit 38, the mass pass/fail determination unit 42, and the foreign matter determination unit 43 by software. The program is stored in advance in the ROM or the HDD. Alternatively, the program may be provided or distributed in a state of being recorded on a computer-readable recording medium such as a compact disc or a DVD in an installable or executable form. Alternatively, the program may be stored in a computer connected to a network such as the Internet, and provided or distributed by downloading the program via the network.

The display unit 45 is configured by, for example, a display device such as a liquid crystal display (LCD) or a cathode ray tube (CRT), and displays various determination results, measurement results, and the like based on a display control signal from the control unit 50. The display unit 45 may have an operation function of the operation unit 46 such as a soft key on a display screen.

The operation unit 46 is used to receive the operation input performed by the user and is configured by, for example, an operation knob, various keys, a switch, a button, or a user interface such as the soft key on the display screen of the display unit 45. Alternatively, the operation unit 46 may include an input device such as a keyboard or a mouse.

For example, the operation input performed by the user on the operation unit 46 enables the selection of the operation mode of the X-ray inspection apparatus 1 in the mode switching unit 30 or the selection of the table corresponding to the type of the inspection object 100.

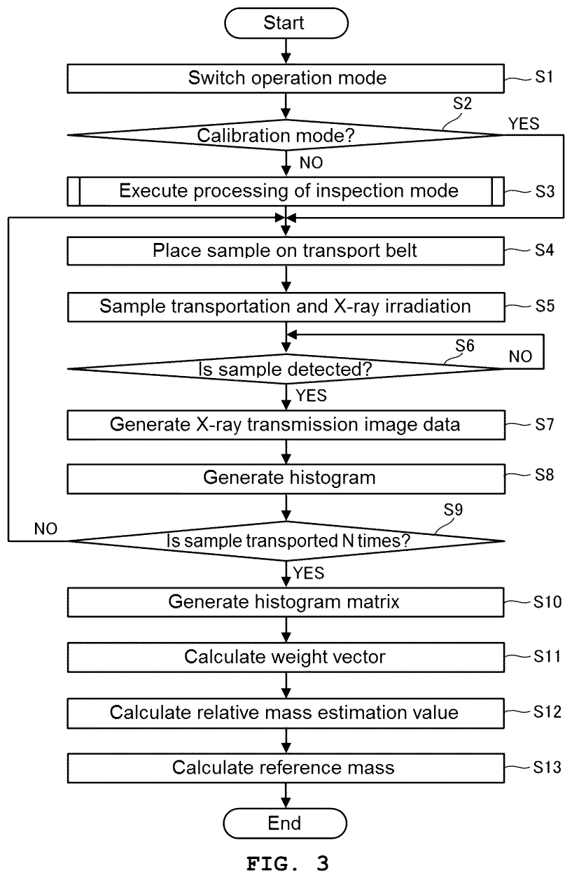

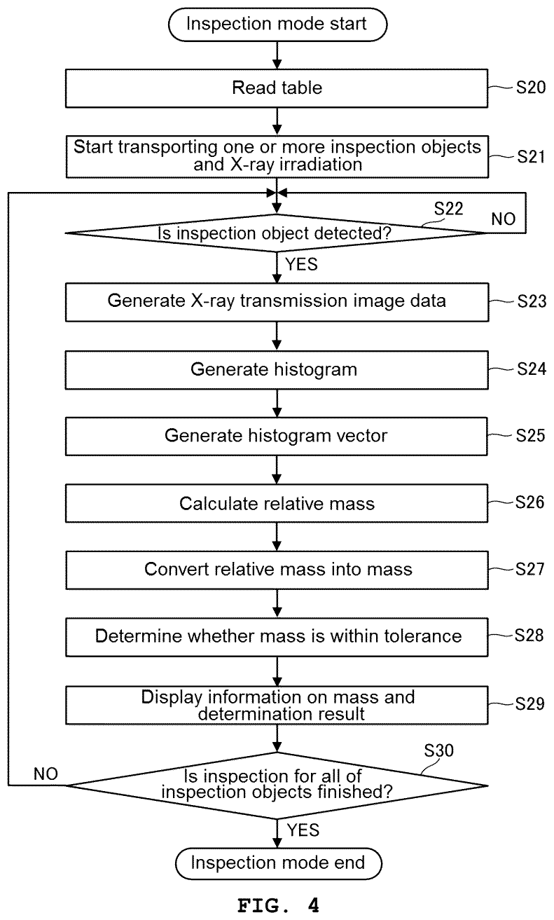

Hereinafter, an example of processing in the mass estimation method using the X-ray inspection apparatus 1 will be described with reference to the flowcharts in FIGS. 3 and 4. The description overlapping with the description of the configuration of the X-ray inspection apparatus 1 will be appropriately omitted. The processing of each step in the flowcharts of FIGS. 3 and 4 is realized by the computer that constitutes the control unit 50 executing the program.

First, the mode switching unit 30 switches the operation mode of the X-ray inspection apparatus 1 (step S1). The switching of the operation mode via the mode switching unit 30 is executed, for example, at a timing of the operation input performed by the user on the operation unit 46, at a time designated in advance, or at a timing such as several seconds after the start of the operation of the X-ray inspection apparatus 1.

In a case where the operation mode switched by the mode switching unit 30 in step S1 is the calibration mode (step S2: YES), the control unit 50 executes the processing of the calibration mode in step S4 and subsequent steps.

In a case where the operation mode switched by the mode switching unit 30 in step S1 is the inspection mode (step S2: NO), the control unit 50 executes the processing of the inspection mode (step S3).

In step S4, the sample of the inspection object 100 is placed on the transport belt 11 by the user or the dedicated device (step S4).

In a case where the user performs the operation input to give an instruction to start the measurement on the operation unit 46, the transport unit 10 starts transporting the sample of the inspection object 100 placed on the transport belt 11. Then, the X-ray source 21 irradiates the sample, which is transported by the transport unit 10 and passes through the predetermined inspection section, with the X-rays (first transport step S5).

Then, in a case where the entry of one sample into the inspection section is detected by an entry detection sensor (not shown) (step S6: YES), the X-ray transmission image data generation unit 31 generates the X-ray transmission image data corresponding to the transmission amount of the X-rays for each transmission region of the sample transported by the first transport step S5 (first X-ray transmission image data generation step S7).

Then, the histogram generation unit 32 generates the histogram of the pixel values of the plurality of pixels included in the X-ray transmission image data of the sample generated in the first X-ray transmission image data generation step S7 (first histogram generation step S8).

Then, in a case where the sample is not transported N times (step S9: NO), the processing in step S4 and subsequent steps is executed again.

On the other hand, in a case where the sample is transported N times (step S9: YES), the histogram matrix generation unit 33 generates the histogram matrix consisting of the N row vectors corresponding to the N histograms of the sample generated in the first histogram generation step S8 (histogram matrix generation step S10).

Then, the weight vector calculation unit 34 calculates the weight vector w that minimizes the variance of the N relative mass estimation values constituting the relative mass estimation value vector W, which is obtained based on the histogram matrix (weight vector calculation step S11). In this case, the control unit 50 stores the weight vector w, which is calculated in the weight vector calculation step S11, in the table of the storage unit 35 in association with the type of the inspection object 100.

Then, the relative mass estimation value vector calculation unit 36 calculates the product of the histogram matrix and the weight vector w calculated in the weight vector calculation step S11 as the relative mass estimation value vector W (relative mass estimation value vector calculation step S12).

Then, the reference mass calculation unit 37 calculates the representative value of the N relative mass estimation values included in the relative mass estimation value vector W calculated in the relative mass estimation value vector calculation step S12 as the reference mass W_{Sm} (reference mass calculation step S13). In this case, the control unit 50 stores the reference mass W_{Sm}, which is calculated in the reference mass calculation step S13, in the table of the storage unit 35 in association with the type of the inspection object 100.

Hereinafter, details of the processing of step S3 will be described with reference to the flowchart of FIG. 4.

First, the table corresponding to the type of the inspection object 100 is read from the storage unit 35 based on the operation input performed by the user on the operation unit 46 (step S20).

Then, in a case where the user performs the operation input to give the instruction to start the measurement on the operation unit 46, the transport unit 10 starts sequentially transporting the one or more inspection objects 100 placed on the transport belt 11 by the user or the dedicated device. Then, the X-ray source 21 irradiates the inspection object 100 that is transported by the transport unit 10 and passes through the predetermined inspection section, with the X-rays (second transport step S21).

Then, in a case where the entry of one inspection object 100 into the inspection section is detected by an entry detection sensor (not shown) (step S22: YES), the X-ray transmission image data generation unit 31 generates the X-ray transmission image data corresponding to the transmission amount of the X-rays for each transmission region of the inspection object 100 transported to the inspection section by the second transport step S21 (second X-ray transmission image data generation step S23).

Then, the histogram generation unit 32 generates the histogram of the pixel values of the plurality of pixels included in the X-ray transmission image data of the inspection object 100 generated in the second X-ray transmission image data generation step S23 (second histogram generation step S24).

Then, the histogram vector generation unit 39 generates the histogram vector consisting of one row vector corresponding to the histogram of the inspection object 100 generated in the second histogram generation step S24 (histogram vector generation step S25).

Then, the relative mass calculation unit 40 calculates the product of the histogram vector and the weight vector w stored in the table of the storage unit 35 as the relative mass Wᵣₘ of the inspection object 100 (relative mass calculation step S26).

Then, the mass conversion unit 41 converts the relative mass Wᵣₘ calculated in the relative mass calculation step S26 into the mass of the inspection object 100 based on the ratio between the known mass W_{Km} of the sample stored in the table of the storage unit 35 and the reference mass W_{Sm} (mass conversion step S27).

Then, the mass pass/fail determination unit 42 determines whether the mass converted in the mass conversion step S27 is within the predetermined mass tolerance corresponding to the inspection object 100 (mass pass/fail determination step S28).

Then, the display unit 45 displays the information on the mass of the inspection object 100 converted in the mass conversion step S27 and the determination result obtained in the mass pass/fail determination step S28 (step S29).

Then, in a case where the information on the mass and the determination result for all of the inspection objects 100 is acquired, that is, in a case where the inspection of all of the inspection objects 100 is finished (step S30: YES), the series of processing is finished. In a case where the inspection for all of the inspection objects 100 is not finished (step S30: NO), the processing in step S22 and subsequent steps is executed again.

The histogram vector generation step S25, the relative mass calculation step S26, and the mass conversion step S27 constitute a mass estimation step of estimating the mass of the inspection object 100 by using the weight vector w calculated in the weight vector calculation step S11 in the inspection mode in which the one or more inspection objects 100 are transported.

As described above, with the mass estimation method and the X-ray inspection apparatus according to the present embodiment, in the calibration mode, the X-ray transmission image data of the sample of the inspection object 100 is generated N times, and the weight vector w consisting of the weight coefficients wᵢ for each pixel value of the plurality of pixels included in each of the N pieces of X-ray transmission image data can be calculated. That is, with the mass estimation method and the X-ray inspection apparatus according to the present embodiment, a relationship between the pixel value and the mass is not approximated by a curve such as Expression (3) as in the related art, but the weight coefficient wᵢ, which is the correction coefficient for calculating the mass of the inspection object 100, is calculated for each pixel value. As a result, with the mass estimation method and the X-ray inspection apparatus according to the present embodiment, the mass of the inspection object 100 can be estimated with high estimation accuracy by using the weight vector w in the inspection mode.

In addition, with the mass estimation method and the X-ray inspection apparatus according to the present embodiment, the reference mass W_{Sm} in a case of estimating the mass of the inspection object 100 can be calculated.

In addition, with the mass estimation method and the X-ray inspection apparatus according to the present embodiment, the relative mass Wᵣₘ of the inspection object 100 can be calculated by using the weight vector w, and the relative mass Wᵣₘ can be converted into the mass of the inspection object 100 based on the ratio between the known mass W_{Km} of the sample and the reference mass W_{Sm}.

In addition, with the mass estimation method and the X-ray inspection apparatus according to the present embodiment, whether the mass of the inspection object 100 is within the predetermined mass tolerance can be determined.

In addition, the X-ray inspection apparatus according to the present embodiment can determine whether the foreign matter is contained in the inspection object 100.

### DESCRIPTION OF REFERENCE NUMERALS AND SIGNS

1: X-ray inspection apparatus
10: transport unit
20: X-ray inspection unit
21: X-ray source
24: X-ray detector
30: mode switching unit
31: X-ray transmission image data generation unit
32: histogram generation unit
33: histogram matrix generation unit
34: weight vector calculation unit
35: storage unit
36: relative mass estimation value vector calculation unit
37: reference mass calculation unit
38: mass estimation unit
39: histogram vector generation unit
40: relative mass calculation unit
41: mass conversion unit
42: mass pass/fail determination unit
43: foreign matter determination unit
45: display unit
46: operation unit
50: control unit
100: inspection object (or sample)

What is claimed is:

1. A mass estimation method comprising:
a first transport step of transporting a sample that is the same type as an inspection object and that has known mass N times while irradiating the sample with X-rays;
a first X-ray transmission image data generation step of generating, for each transportation, X-ray transmission image data corresponding to a transmission amount of the X-rays for each transmission region of the sample transported in the first transport step;
a first histogram generation step of generating a histogram of pixel values of pixels that are included in N pieces of the X-ray transmission image data of the sample generated in the first X-ray transmission image data generation step and that correspond to the respective transmission regions;
a histogram matrix generation step of generating a histogram matrix consisting of N row vectors corresponding to N histograms of the sample generated in the first histogram generation step;
a weight vector calculation step of using a product of the histogram matrix and a weight vector consisting of a weight coefficient for each pixel value of the N pieces of X-ray transmission image data as a relative mass estimation value vector consisting of N relative mass estimation values of the sample, to calculate the weight vector that minimizes a variance of the N relative mass estimation values; and
a mass estimation step of estimating mass of the inspection object that is transported, by using the weight vector calculated in the weight vector calculation step.

2. The mass estimation method according to claim 1, further comprising:
a relative mass estimation value vector calculation step of calculating the product of the histogram matrix and the weight vector calculated in the weight vector calculation step as the relative mass estimation value vector; and
a reference mass calculation step of calculating a representative value of the N relative mass estimation values included in the relative mass estimation value vector calculated in the relative mass estimation value vector calculation step as reference mass.

3. The mass estimation method according to claim 2, further comprising:
a second transport step of sequentially transporting one or more inspection objects that are transported, while irradiating the one or more inspection objects with X-rays;
a second X-ray transmission image data generation step of generating X-ray transmission image data corresponding to a transmission amount of the X-rays for each transmission region of the inspection object transported in the second transport step; and
a second histogram generation step of generating a histogram of pixel values of pixels that are included in the X-ray transmission image data of the inspection object generated in the second X-ray transmission image data generation step and that correspond to the respective transmission regions,
wherein the mass estimation step includes
a histogram vector generation step of generating a histogram vector consisting of one row vector corresponding to the histogram of the inspection object generated in the second histogram generation step,
a relative mass calculation step of calculating a product of the histogram vector and the weight vector calculated in the weight vector calculation step as relative mass of the inspection object, and
a mass conversion step of converting the relative mass into the mass of the inspection object based on a ratio between the known mass of the sample and the reference mass.

4. The mass estimation method according to claim 3, further comprising:
a mass pass/fail determination step of determining whether the mass converted in the mass conversion step is within a predetermined mass tolerance corresponding to the inspection object.

5. An X-ray inspection apparatus comprising:
a transport unit that transports a sample that is the same type as an inspection object and that has known mass N times;
an X-ray source that irradiates the sample transported by the transport unit with X-rays;
an X-ray detector that detects the X-rays transmitted through the sample for each transmission region of the sample;
an X-ray transmission image data generation unit that generates, for each transportation, X-ray transmission image data corresponding to a transmission amount of the X-rays for each transmission region of the sample based on detection information of the X-ray detector;
a histogram generation unit that generates a histogram of pixel values of pixels that are included in N pieces of the X-ray transmission image data of the sample generated by the X-ray transmission image data generation unit and that correspond to the respective transmission regions;
a histogram matrix generation unit that generates a histogram matrix consisting of N row vectors corresponding to N histograms of the sample generated by the histogram generation unit;
a weight vector calculation unit that uses a product of the histogram matrix and a weight vector consisting of a weight coefficient for each pixel value of the N pieces of X-ray transmission image data as a relative mass estimation value vector consisting of N relative mass estimation values of the sample, to calculate the weight vector that minimizes a variance of the N relative mass estimation values; and
a mass estimation unit that estimates mass of one or more inspection objects transported by the transport unit, by using the weight vector calculated by the weight vector calculation unit.

6. The X-ray inspection apparatus according to claim 5, further comprising:
a relative mass estimation value vector calculation unit that calculates the product of the histogram matrix and the weight vector calculated by the weight vector calculation unit as the relative mass estimation value vector; and
a reference mass calculation unit that calculates a representative value of the N relative mass estimation values included in the relative mass estimation value vector calculated by the relative mass estimation value vector calculation unit as reference mass.

7. The X-ray inspection apparatus according to claim 6,
wherein, in an inspection mode in which the one or more inspection objects are transported by the transport unit,
the X-ray source irradiates the inspection object that is transported by the transport unit with X-rays, the X-ray detector detects the X-rays transmitted through the inspection object for each transmission region of the inspection object,
the X-ray transmission image data generation unit generates the X-ray transmission image data corresponding to a transmission amount of the X-rays for each transmission region of the inspection object based on detection information of the X-ray detector, and
the histogram generation unit generates a histogram of pixel values of pixels that are included in the X-ray transmission image data of the inspection object generated by the X-ray transmission image data generation unit and that correspond to the respective transmission regions, and
the mass estimation unit includes
a histogram vector generation unit that generates a histogram vector consisting of one row vector corresponding to the histogram of the inspection object generated by the histogram generation unit,
a relative mass calculation unit that calculates a product of the histogram vector and the weight vector calculated by the weight vector calculation unit as relative mass of the inspection object, and
a mass conversion unit that converts the relative mass into the mass of the inspection object based on a ratio between the known mass of the sample and the reference mass.

8. The X-ray inspection apparatus according to claim 5, further comprising:
a foreign matter determination unit that determines whether a foreign matter is contained in the inspection object based on the detection information of the X-ray detector.

9. The X-ray inspection apparatus according to claim 6, further comprising:
a foreign matter determination unit that determines whether a foreign matter is contained in the inspection object based on the detection information of the X-ray detector.

10. The X-ray inspection apparatus according to claim 7, further comprising:
a foreign matter determination unit that determines whether a foreign matter is contained in the inspection object based on the detection information of the X-ray detector.
